(19) United States
(12) Patent Application Publication
(10) Pub. No.: US 2026/0338320 A1
(43) Pub. Date: Oct. 29, 2026

(54) DETACHABLE SUPPORTING FOOT, SUPPORTING LEG, AND PHOTOGRAPHY STAND

(71) Applicant: SHENZHEN LEQI INNOVATION CO., LTD., Shenzhen City (CN)

(72) Inventor: SHAORUI TANG, Shenzhen City (CN)

(73) Assignee: SHENZHEN LEQI INNOVATION CO., LTD., Shenzhen City (CN)

(21) Appl. No.: 19/703,052

(22) Filed: Jun. 9, 2026

Related U.S. Application Data
(63) Continuation of application No. PCT/CN2024/097517, filed on Jun. 5, 2024.

(30) Foreign Application Priority Data
Dec. 14, 2023 (CN) 202323427046.5

(51) Int. Cl. F16M 11/36; F16M 7/00; G03B 17/56

(52) U.S. Cl. CPC F16M 11/36; F16M 7/00; G03B 17/561

(57) ABSTRACT

The present invention discloses a detachable supporting foot comprising a base, a driving component, a return elastic component, and a spike component. The driving component, the return elastic component, and the spike component are mounted on the base, the spike component is used for external connection to a leg, the driving component is pivotally connected to the base; the driving component comprises a pressing portion and a catch hook; the driving component is movable between a first position and a second position. The user can directly step on the pressing portion with the foot downward, thereby preventing the spike component from being detached from the base, realizing the conversion of the foot from horseshoe mode to spike mode. The operation is flexible and convenient, eliminating the need for the user to bend down for manual operation, thus saving time and labor and enhancing user experience.

### CROSS-REFERENCE TO RELATED APPLICATION

The present invention is a continuation of International Patent Application No. PCT/CN2024/097517 filed on Jun. 5, 2024, which claims the priority of Chinese Patent Application No. 202323427046.5, filed on Dec. 14, 2023, the entire contents of which are incorporated herein by reference.

### TECHNICAL FIELD

The present invention relates to the technical field of photography equipment, and particularly relates to a detachable supporting foot, a supporting leg having the supporting foot, and a photography stand.

### BACKGROUND

Photography stands are used to support photographic and video equipment such as mobile phones, cameras, monitors, microphones, and the like. Photography stands can be used to fix and adjust the height and levelness of the photographic and video equipment, so as to facilitate the photographic and video equipment in performing photography and video recording work. Photography stands may be supporting structures such as monopods, tripods, and the like. Existing supporting legs of tripods are provided with supporting feet, and the supporting feet are inconvenient to operate when switching between horseshoe mode and spike mode., each switching operation requiring bending down to perform the operation manually, which is time-consuming and laborious.

### SUMMARY

The primary object of the present invention is to provide a detachable supporting foot, aiming to solve the technical problem that the conversion between horseshoe mode and spike mode. is time-consuming and laborious in the current legs.

To achieve the above object, the present invention provides a detachable supporting foot for supporting photographic and video equipment. The detachable supporting foot comprises a base, a driving component, a return elastic component, and a spike component; wherein the driving component, the return elastic component, and the spike component are mounted on the base, the spike component is used for external connection to a leg, the driving component is pivotally connected to the base; the driving component comprises a pressing portion and a catch hook; the driving component is movable between a first position and a second position; at the first position, the catch hook is hooked with the spike component; at the second position, the catch hook is separated from the spike component so that the spike component can be detached from the base, and the return elastic component applies a restoring force to the driving component to return to the first position, actuating the pressing portion to cause the driving component to move.

In some embodiments, the spike component is rotatably connected to the base through a pivot shaft, the catch hook has a hook groove adapted to receive the pivot shaft, and the catch hook and the pivot shaft have a hooked state and a disengaged state.

In some embodiments, the base is recessed with a mounting groove, the pressing portion is located outside the mounting groove, one end of the return elastic component is connected to an inner groove wall of the mounting groove, and the other end of the return elastic component is fixedly connected to the driving component, and the pivot shaft passes through the hook groove and is rotatably connected to the inner groove wall of the mounting groove.

In some embodiments, the return elastic component is a spring or made of elastic material.

In some embodiments, the return elastic component comprises an extending portion, a first circular portion, and a second circular portion; the first circular portion protrudes from one end of the extending portion, the second circular portion protrudes from the other end of the extending portion; the inner groove wall of the mounting groove is recessed with a first circular limiting groove matching the first circular portion, and the driving component is recessed with a second circular limiting groove matching the second circular portion.

In some embodiments, the first circular limiting groove is connected to a first elongated groove, and an end of the first elongated groove distal from the first circular limiting groove is open; and/or

the second circular limiting groove is connected to a second elongated groove, and an end of the second elongated groove away from the first circular limiting groove extends out of a side edge of the driving component.

In some embodiments, the driving component comprises two connecting portions, an outer side surface of a first end of the connecting portion is rotatably connected to the inner groove wall of the mounting groove through a shaft rod, a second end of the connecting portion extending upward has the catch hook, a third end of the connecting portion is fixedly connected to the pressing portion, a receiving space is formed between the two connecting portions to rotatably receive a portion of the spike component, the first end portion, the second end portion, and the third end of the connecting portion are distributed in a triangular shape, and the second circular limiting groove is located between the first end portion and the second end of the connecting portion; and/or

the extending portion is elongated in shape.

In some embodiments, the bottom groove wall of the mounting groove is provided with a supporting portion protruding therefrom, and when the spike component rotates, a bottom side of the spike component is provided with a sliding portion that slides along a top surface of the supporting portion; and/or

the bottom side of the spike component is provided with two conical spikes spaced apart from each other; and/or

an upper surface of the catch hook is an arc surface, and the pivot shaft slides along the arc surface of the catch hook to slide into the hook groove.

In some embodiments, the driving component is pivotally mounted to the base via a shaft rod, the driving component being rotatable about the shaft rod between the first position and the second position; the spike component is pivotally connected to the base via a pivot shaft arranged parallel to the shaft rod, such that an angular position of the spike component relative to the base is adjustable and the spike component is locked at a present angle through engagement between the catch hook and the pivot shaft.

In some embodiments, the return elastic component is an extension elastic component, one end of the return elastic component is connected to the base, and the other end of the return elastic component is connected to the driving component; or the return elastic component is a torsion elastic component sleeved on the shaft rod, and two torsion arms thereof respectively abut against the base and the driving component.

In some embodiments, the return elastic component comprises an elongated extending portion, a first circular portion, and a second circular portion, and the first circular portion and the second circular portion being respectively disposed at two ends of the extension portion; the base is formed with a first circular limiting groove matching the first circular portion, and the driving component is formed with a second circular limiting groove matching the second circular portion.

In some embodiments, the pivot shaft is located on the extending portion when the spike member is mounted to the base.

In some embodiments, the catch hook is formed with a hook groove adapted to the pivot shaft, an upper surface of the hook at a junction with the hook groove is a curved surface, and the pivot shaft is capable of sliding along the upper surface of the hook to slip into the hook groove.

In some embodiments, the base is provided with a support portion, the spike component is provided with a sliding portion at a bottom thereof; a bottom surface of the sliding portion is curved about the pivot shaft, and a top surface of the support portion is correspondingly recessed to form a curved surface, such that the sliding portion slides smoothly on the support portion when adjusting the angular position of the spike component relative to the base.

In some embodiments, two conical spikes spaced apart from each other protrude from the bottom of the spike component for fixing and preventing sliding, and the sliding portion is formed between the two conical spikes.

In some embodiments, a leg connecting sleeve is provided at an upper portion of the spike component for connection with a leg portion, the leg portion capable of being inserted into the leg connecting sleeve to be secured thereto.

The present invention also provides a supporting leg with a supporting foot. The supporting leg comprises comprising a leg portion and the detachable supporting foot, wherein a bottom end of the leg portion is fixedly connected to the spike component.

In some embodiments, the leg portion is telescopically arranged.

The present invention also provides a photography stand. The photography stand comprises a mounting seat and three supporting legs, wherein an upper end portion of each supporting leg is rotatably connected to the mounting seat.

The present invention has the following beneficial effects. In this embodiment, the bottom surface of the base is a flat surface. The base is used on relatively smooth ground and can effectively prevent the tripod from sliding. The spike component is used on relatively rough outdoor ground. The bottom side of the spike component is provided with two conical spikes spaced apart from each other, which are used for fixing and preventing sliding during use. Existing feet are inconvenient to operate when converting between horseshoe mode and spike mode. Each conversion operation requires bending down to operate by hand, which is time-consuming and laborious. In this embodiment, after assembly, the driving component is at the first position, the catch hook is hooked with the spike component, and the spike component cannot be detached from the base. During the process of the driving component moving from the first position to the second position, when the pressing portion is actuated, the driving component rotates toward the second position, the return elastic component is stretched to generate a restoring force, and the catch hook gradually separates from the spike component. At the second position of the driving component, the catch hook is separated from the spike component, so that the spike component can be detached from the base. At this time, the return elastic component applies a restoring force to the driving component to return to the first position. After releasing the pressing portion, the return elastic component drives the driving component to reset. The user can directly step on the pressing portion with the foot downward, thereby preventing the spike component from being detached from the base, realizing the conversion of the foot from horseshoe mode to spike mode. The operation is flexible and convenient, eliminating the need for the user to bend down for manual operation, thus saving time and labor and enhancing user experience.

### BRIEF DESCRIPTION OF THE DRAWINGS

FIG. 1 is a structural schematic diagram of a detachable supporting foot according to an embodiment of the present invention;

FIG. 2 is an exploded view of the detachable supporting foot in the embodiment of FIG. 1;

FIG. 3 is a further exploded view of the detachable supporting foot in the embodiment of FIG. 1;

FIG. 4 is a further exploded view of the detachable supporting foot from another angle in the embodiment of FIG. 1;

FIG. 5 is a structural schematic diagram of the detachable supporting foot with a base removed in the embodiment of FIG. 1;

FIG. 6 is a structural schematic diagram of the base in the embodiment of FIG. 1;

FIG. 7 is a side view of the base in the embodiment of FIG. 1;

FIG. 8 is a cross-sectional view of the base in FIG. 7 taken along line A-A;

FIG. 9 is a side view of the detachable supporting foot in the embodiment of FIG. 1;

FIG. 10 is a cross-sectional view of the detachable supporting foot in FIG. 9 taken along line B-B;

FIG. 11 is a cross-sectional view of the detachable supporting foot in FIG. 9 taken along line C-C;

FIG. 12 is a structural schematic diagram of a supporting leg according to an embodiment of the present invention;

FIG. 13 is a structural schematic diagram of a photography stand according to an embodiment of the present invention.

In the drawings:

supporting foot 100;

base 10; mounting groove 11; first circular limiting groove 12; supporting portion 13; clearance groove 14; shaft rod receiving hole 15; first elongated groove 16;

driving component 20; pressing portion 21; catch hook 22; connecting portion 23; second circular limiting groove 24; second elongated groove 25; shaft rod 26; receiving space 27; hook groove 28;

return elastic component 30; extending portion 31; first circular portion 32; second circular portion 33;

spike component 40; pivot shaft 41; conical spike 42; leg connecting sleeve 43; sliding portion 44;

leg portion 200;

mounting seat 300.

### DETAILED DESCRIPTION OF THE EMBODIMENTS

Hereinafter, the embodiments of the present invention will be described clearly and completely in conjunction with the accompanying drawings in the embodiments of the present invention. Apparently, the described embodiments are only a part of the embodiments of the present invention, rather than all the embodiments. Based on the embodiments of the present invention, all other embodiments obtained by those of ordinary skill in the art without making creative efforts shall fall within the protection scope of the present invention.

It should be noted that all directional indications (such as up, down, left, right, front, back...) in the embodiments of the present invention are only used to explain the relative positional relationship, movement situation, etc. between various components in a specific posture (as shown in the drawings). If the specific posture changes, the directional indication will change accordingly.

It should also be noted that when an element is referred to as being "fixed to" or "disposed on" another element, it can be directly on the other element or there may be an intermediate element simultaneously. When an element is referred to as being "connected" to another element, it can be directly connected to the other element or there may be an intermediate element simultaneously.

In addition, the descriptions involving "first," "second," etc. in the present invention are only for descriptive purposes and should not be understood as indicating or implying their relative importance or implicitly indicating the number of indicated technical features. Thus, features defined as "first," "second" may explicitly or implicitly include at least one of such features. In addition, technical solutions among various embodiments may be combined with each other, but must be based on what can be achieved by those of ordinary skill in the art. When the combination of technical solutions is contradictory or cannot be realized, it should be considered that such combination of technical solutions does not exist and is not within the protection scope required by the present invention.

In addition, the descriptions involving "first," "second," etc. in the present invention are only for descriptive purposes and should not be understood as indicating or implying their relative importance or implicitly indicating the number of indicated technical features. Thus, features defined as "first," "second" may explicitly or implicitly include at least one of such features. In addition, technical solutions among various embodiments may be combined with each other, but must be based on what can be achieved by those of ordinary skill in the art. When the combination of technical solutions is contradictory or cannot be realized, it should be considered that such combination of technical solutions does not exist and is not within the protection scope required by the present invention.

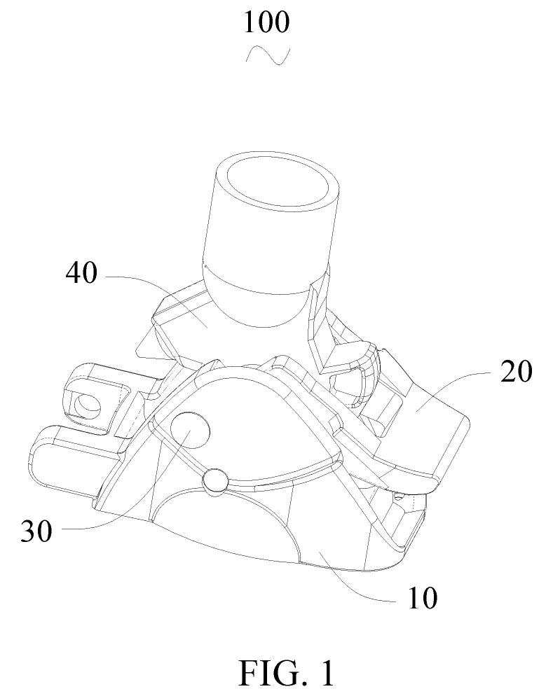

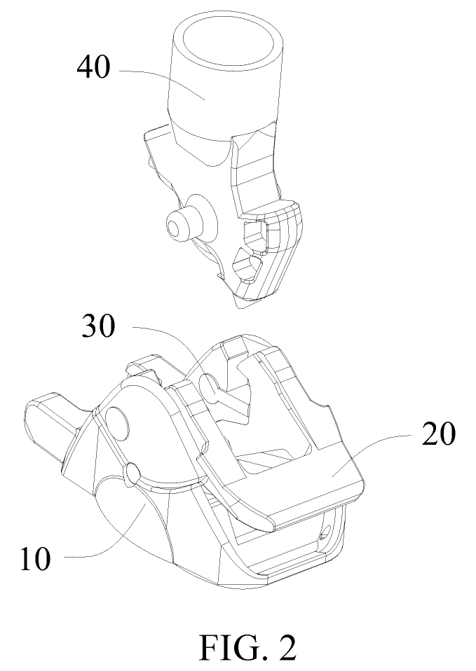

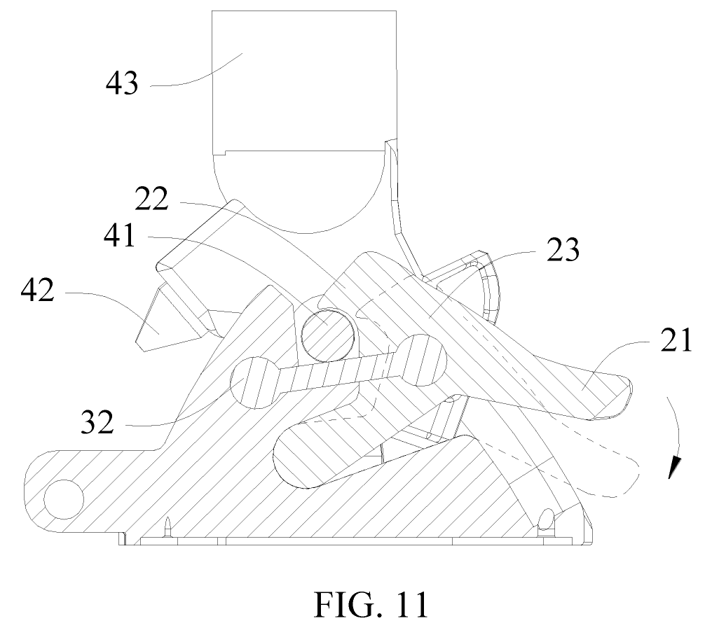

The present invention provides a detachable supporting foot. Referring to FIGS. 1-3, a detachable supporting foot 100 of the present invention is used for supporting a supporting leg, which can be used for photographic and video equipment. The photographic and video equipment is used for supporting photographic and video devices, which include electronic products such as mobile phones, cameras, monitors, etc. The photographic and video equipment includes photographic accessories requiring feet such as monopods, tripods, etc. Taking a tripod as an example below, the detachable supporting foot 100 comprises a base 10, a driving component 20, a return elastic component 30, and a spike component 40. The driving component 20, the return elastic component 30, and the spike component 40 are all mounted on the base 10. The spike component 40 is used for external connection to a supporting leg. The driving component 20 is pivotally connected to the base 10. The driving component 20 comprises a pressing portion 21 and a catch hook 22. The driving component 20 is movable between a first position and a second position. The first position and the second position of the driving component 20 are shown in FIG. 11.

A bottom surface of the base 10 is a flat surface. The base 10 is used on relatively smooth ground and can effectively prevent the tripod from sliding. The spike component 40 is used on relatively rough outdoor ground. A bottom side of the spike component 40 is provided with two conical spikes 42 spaced apart from each other, which are used for fixing and preventing sliding during use.

Existing feet are inconvenient to operate when converting between horseshoe mode and spike mode. Each conversion operation requires the operator to bend down and manipulate by hand, which is time-consuming and laborious. In this embodiment, after assembly, the driving component 20 is at the first position (as shown in solid lines in FIG. 11), the catch hook 22 is hooked with the spike component 40, and the spike component 40 cannot be detached from the base 10.

The driving component 20 is pivotally mounted to the base 10 via a shaft rod 26, the driving component 20 being rotatable about the shaft rod 26 between the first position (as shown in solid lines in FIG. 11) and the second position (as shown in dashed lines in FIG. 11). During movement of the driving component 20 from the first position to the second position, upon actuation of the pressing portion 21, the driving component 20 pivots from the first position to the second position in the direction shown by the arrow in FIG. 11, the return elastic component 30 is stretched to generate a restoring force, and the catch hook 22 gradually separates from the spike component 40. At the second position of the driving component 20, the catch hook 22 is separated from the spike component 40, so that the spike component 40 can be detached from the base 10. At the same time, the return elastic component 30 exerts a restoring force on the driving component 20 for returning the driving component 20 to the first position. Upon release of the pressing portion 21, the return elastic component 30 drives the driving component 20 to return to the first position. The user may directly depress the pressing portion 21 downward with the foot, so that the spike component 40 is detachable from the base 10, thereby switching the supporting foot 100 from the horseshoe mode to the spike mode. The operation is flexible and convenient, eliminating the need for the user to bend down for manual operation, thus saving time and labor and enhancing user experience.

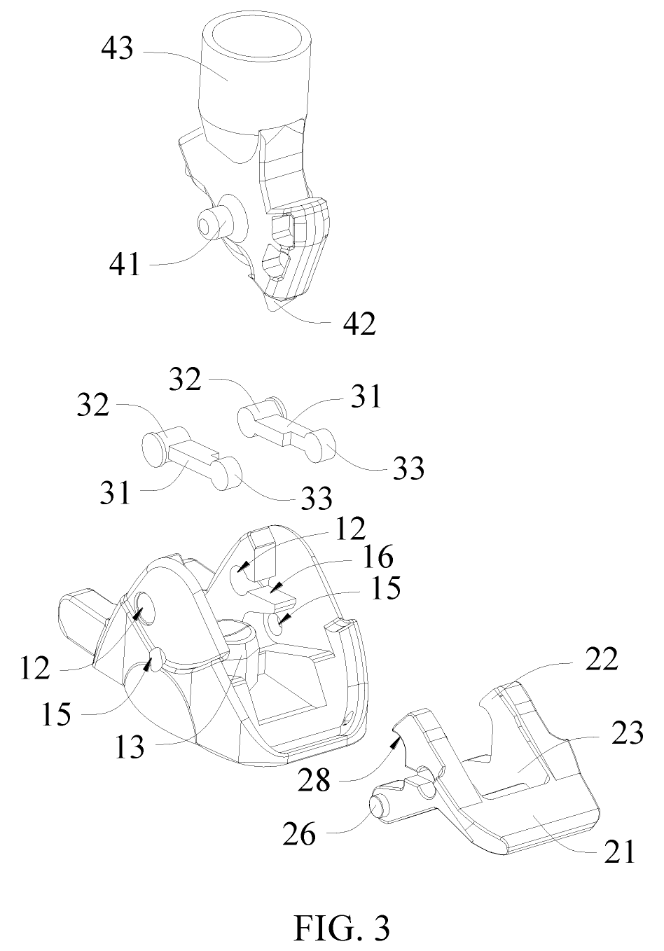

In some embodiments, referring to FIGS. 3-6, the spike component 40 is pivotally connected to the base 10 through a pivot shaft 41. The catch hook 22 is provided with a hook groove 28 adapted to fit the pivot shaft 41. The hook groove 28 is oriented in different directions when the driving component 20 is at the first position and the second position, respectively, so that the catch hook 22 and the pivot shaft 41 are in a hooked state or a disengaged state. One, two, or more than two catch hooks 22 may be engaged with the pivot shaft 41. The pivot shaft 41 is arranged parallel to the shaft rod 26, such that an angular position of the spike component 40 relative to the base 10 is adjustable and the spike component 40 is locked at a present angle through engagement between the catch hook 22 and the pivot shaft 41.

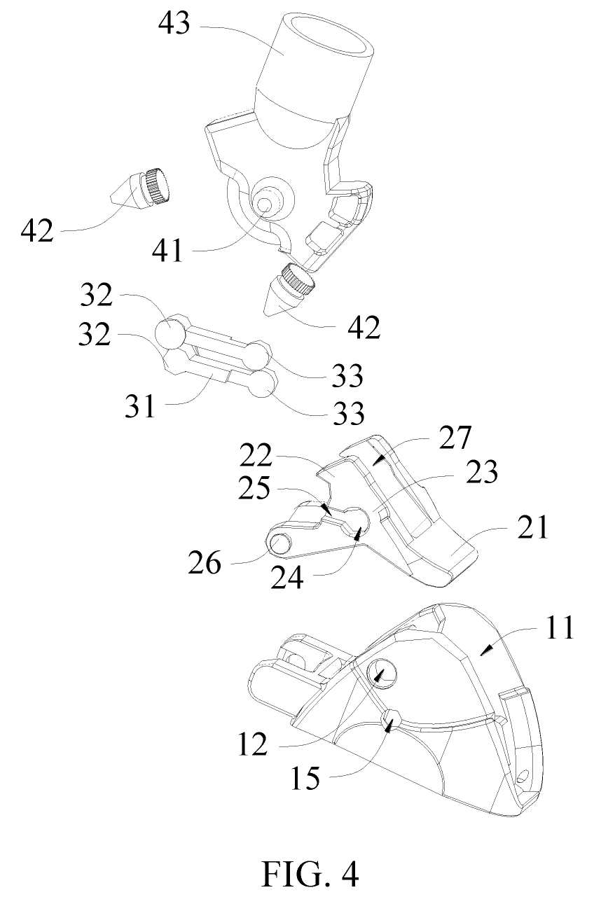

In some embodiments, referring to FIGS. 4 and 6, the base 10 is provided with a mounting groove 11 recessed therein. Two ends of the pivot shaft 41 are respectively and pivotally connected to opposite inner walls of the mounting groove 11. The pressing portion 21 is disposed outside the mounting groove 11 to facilitate foot stepping operation by the user. One end of the return elastic component 30 is connected to an inner wall of the mounting groove 11, and the other end is secured to the driving component 20.

In this embodiment, the return elastic component 30 may be a spring or may be made of elastic material, such as silicone. Referring to FIGS. 3-5, specifically, the return elastic component 30 is made of elastic silicone material. The return elastic component 30 comprises an extending portion 31, a first circular portion 32, and a second circular portion 33. The first circular portion 32 protrudes from one end of the extending portion 31, and the second circular portion 33 protrudes from the other end of the extending portion 31. The inner groove wall of the mounting groove 11 is recessed with a first circular limiting groove 12 matching the first circular portion 32, and the driving component 20 is recessed with a second circular limiting groove 24 matching the second circular portion 33. During the movement of the driving component 20 from the first position to the second position, the extending portion 31 of the return elastic component 30 is stretched to generate a restoring force. The first circular portion 32 and the second circular portion 33 prevent the extending portion 31 from being separated from the first circular limiting groove 12 and the second circular limiting groove 24 respectively when stretched. The structure is simple and easy to install.

In some embodiments, referring to FIGS. 3-5, to enhance the stability of installation and use of the return elastic component 30, the extending portion 31 may be elongated. The first circular limiting groove 12 is in communication with a first elongated groove 16, and one end of the first elongated groove 16 distal from the first circular limiting groove 12 is open; and/or the second circular limiting groove 24 is in communication with a second elongated groove 25, and one end of the second elongated groove 25 distal from the second circular limiting groove 24 extends beyond a lateral side of the driving component 20. At least, one end of the extending portion 31 connected to the first circular portion 32 is retained within the first elongated groove 16; alternatively, one end of the extending portion 31 connected to the second circular portion 33 is retained within the second elongated groove 25; alternatively, both ends of the extending portion 31 are respectively retained in the first elongated groove 16 and the second elongated groove 25, with the extending portion 31 passing through lateral openings of the first elongated groove 16 and the second elongated groove 25. The extending portion 31 may be installed from upper openings of the first circular limiting groove 12, the first elongated groove 16, the second circular limiting groove 24, and the second elongated groove 25, thus facilitating operation.

It is to be noted that the return elastic component 30 is not limited to the extension return elastic component shown in the illustrated embodiment, and a torsion return elastic component may alternatively be adopted. For example, the return elastic component 30 is a torsion spring fitted over the shaft rod 26, with two torsion arms respectively abutting against the base 10 and the driving component 20. Upon depression of the pressing portion 21 of the driving component 20, the two torsion arms of the torsion spring are twisted into compression; when the pressing force on the pressing portion 21 is removed, the torsional restoring force of the torsion spring restores the driving component 20 to the first position.

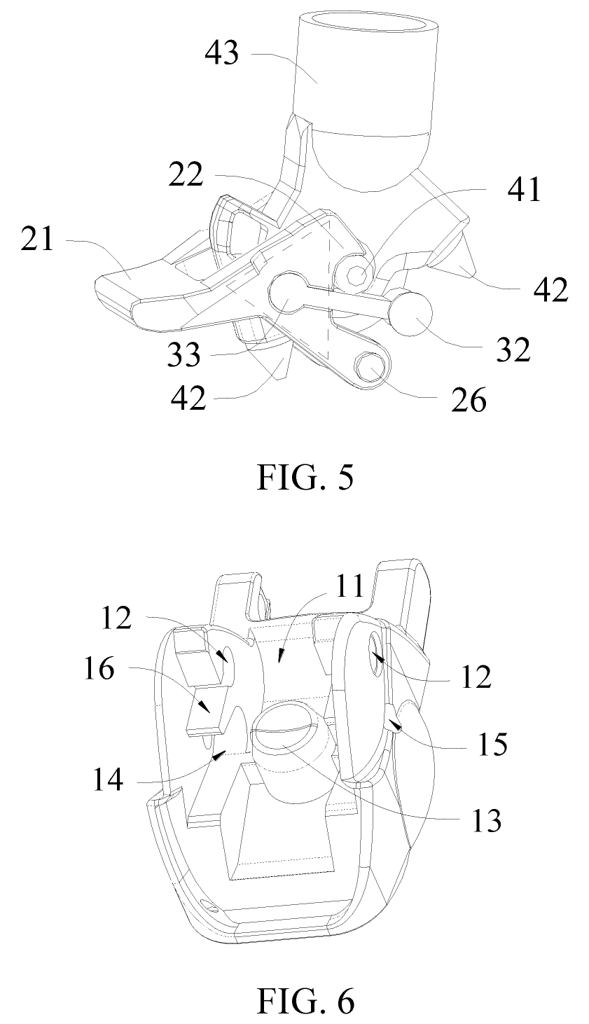

In some embodiments, in order to improve the stability of use of the spike component 40, two ends of the pivot shaft 41 are respectively located on two sides of the spike component 40. Two opposite ends of the pivot shaft 41 respectively pass through the hook groove 28 and are rotatably connected to opposite inner groove walls of the mounting groove 11. The pivot shaft 41 and the spike component 40 may be integrally formed or separately formed. Two ends of the pivot shaft 41 may be respectively hooked by two catch hooks 22 to improve service life. Specifically, the driving component 20 comprises two connecting portions 23, the two connecting portions 23 are arranged in parallel, and a receiving space 27 is formed between the two connecting portions 23 to rotatably receive a portion of the spike component 40. A first end, a second end, and the third end of the connecting portion 23 form a triangular arrangement, as indicated by the dashed lines in FIG. 5. An outer side surface of the first end of the connecting portion 23 is rotatably connected to the inner groove wall of the mounting groove 11 through the shaft rod 26, i.e., the connecting portion 23 has the shaft rod 26 on a side facing the inner groove wall of the mounting groove 11. The second end of the connecting portion 23 extending upward has the catch hook 22. The third end of the connecting portion 23 is fixedly connected to the pressing portion 21. The second circular limiting groove 24 is located between the first end and the second end of the connecting portion 23, saving space and making pressing operation time-saving and labor-saving. In order to reduce occupied space and weight, the edge of the connecting portion 23 may be recessed to form a weight-reducing groove. After assembly, the extending portion 31 is located below the pivot shaft 41, making the connection compact and the structure compact. The return elastic component 30 may be integrally formed or separately formed.

To enhance the rotational stability of the connecting portion 23, the inner wall of the mounting groove 11 is provided with a clearance groove 14 recessed therein, the clearance groove 14 being configured in a flared shape. The first end of the connecting portion 23 rotates within the clearance groove 14, so as to prevent over-pressing of the connecting portion 23 and enhance user experience.

In some embodiments, referring to FIGS. 3 and 6, the bottom wall of the mounting groove 11 is provided with a supporting portion 13 protruding therefrom for supporting the spike component 40 to reduce pressure exerted via the pivot shaft 41. Upon rotation of the spike component 40, a bottom side surface of a sliding portion 44 slides along a top surface of the supporting portion 13. Two conical spikes 42 spaced apart from each other protrude from the bottom side of the spike component 40, and the sliding portion 44 is formed between the two conical spikes 42. The bottom side surface of the sliding portion 44 may be curved about the pivot shaft 41, and the top surface of the support portion 13 is correspondingly recessed to form a curved surface, such that the sliding portion 44 slides smoothly on the support portion 13 when adjusting the angle of the spike component 40 relative to the base 10. The conical spikes 42 may be configured as separate components independent of the spike component 40. A leg connecting sleeve 43 is provided at an upper portion of the spike component 40 for connection with a leg portion, and the leg portion is inserted into the leg connecting sleeve 43 to be secured thereto.

In summary, after assembly, the driving component 20 is at the first position, two catch hooks 22 are hooked with two ends of the pivot shaft 41 of the spike component 40, and the spike component 40 cannot be detached from the base 10.

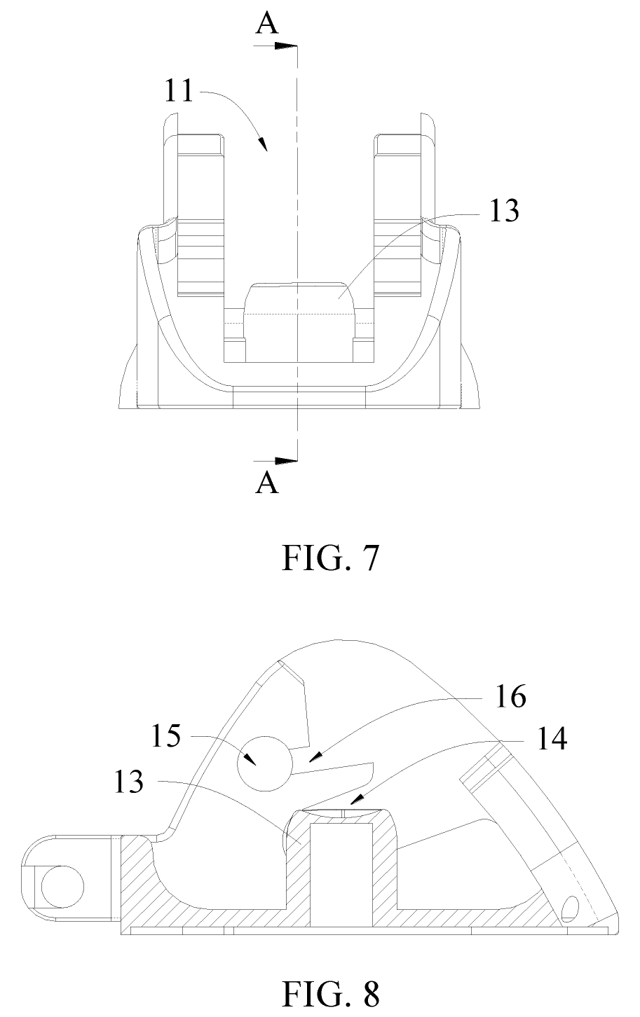

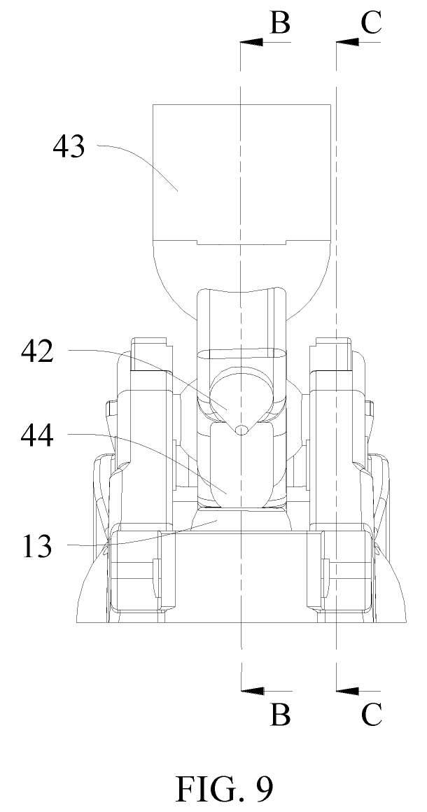

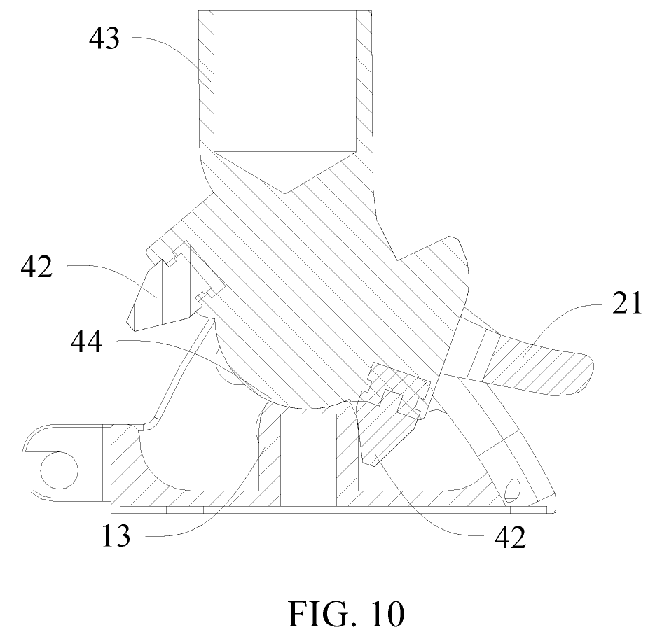

Referring to FIGS. 7-11, during the movement of the driving component 20 from the first position to the second position, upon foot actuation of on the pressing portion 21, the pressing portion 21 drives the two connecting portions 23 to pivot about the shaft rod 26, thereby causing the driving component 20 to rotate toward the second position. At this time, the two return elastic components 30 are extended under tension to produce restoring forces, and the orientation of the catch hooks 22 gradually changes to cause the catch hooks 22 to gradually disengage from the pivot shaft 41. When the driving component 20 reaches the second position, the catch hooks 22 are disengaged from the pivot shaft 41, allowing the spike component 40 to be removed from the base 10. At this time, the return elastic components 30 exert restoring forces on the driving component 20 for returning the driving component 20 to the first position. Upon release of the pressing portion 21, the two return elastic components 30 drive the two connecting portions 23 to pivot about the shaft rod 26 to drive the driving component 20 to return to the first position. When the spike component 40 is to be mounted on the base 10, during sliding of the spike component 40 into the base 10 from above, as both ends of the pivot shaft 41 slide along upper surfaces of the two catch hooks 22, the two connecting portions 23 pivot about the shaft rod 26, so that after both ends of the pivot shaft 41 have slid into the two catch hooks 22, the driving component 20 returns to the first position, thereby facilitating convenient installation.

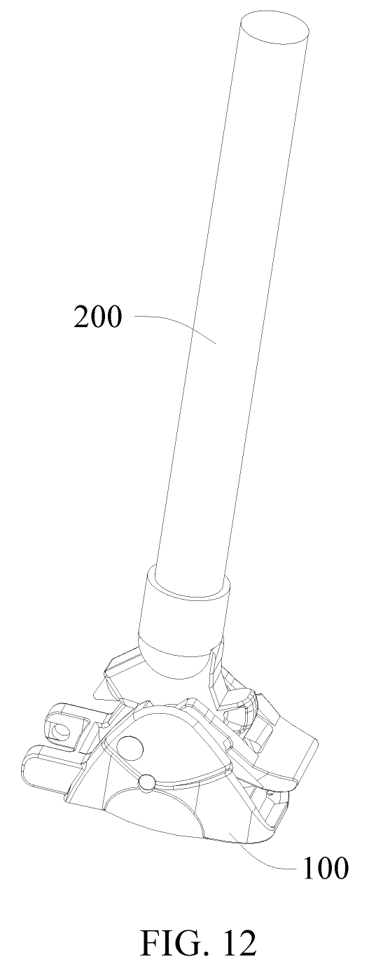

The present invention also provides a supporting leg with a supporting foot. Referring to FIG. 12, the he supporting leg comprises a leg portion 200 and the above-mentioned detachable supporting foot 100. A bottom end of the leg portion 200 is fixedly connected to the leg connecting sleeve 43 of the spike component 40, and the leg portion 200 may be telescopically arranged. For the specific structure of this detachable supporting foot 100, reference is made to the above embodiments. Since this supporting leg with a supporting foot adopts all the technical solutions of all the above embodiments, it at least has all the beneficial effects brought by the technical solutions of the above embodiments, which will not be repeated here.

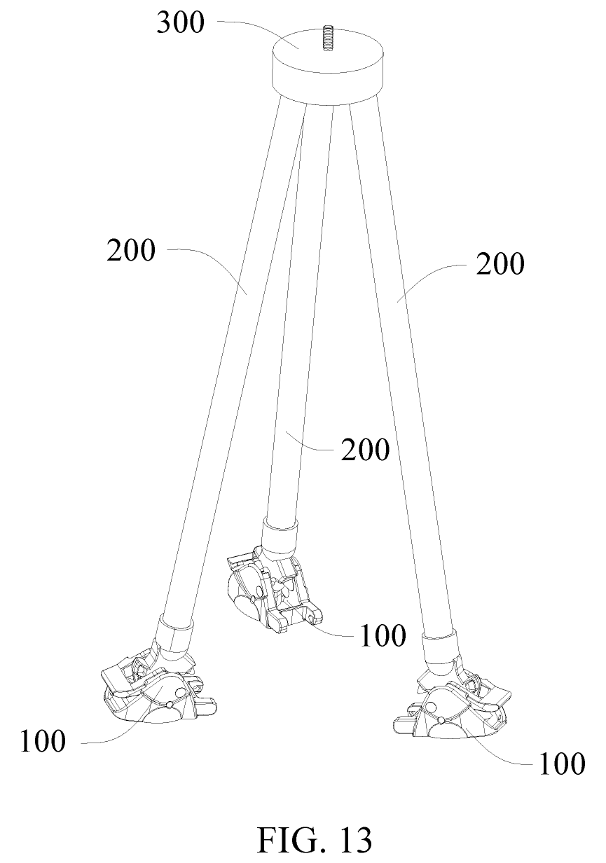

The present invention also provides a photography stand. Referring to FIG. 13, the photography stand comprises a mounting seat 300 and the above-mentioned supporting leg with a supporting foot. There are three supporting legs, and an upper end of each leg portion 200 is rotatably connected to the mounting seat 300. For the specific structure of this supporting leg with a supporting foot, reference is made to the above embodiments. Since this photography stand adopts all the technical solutions of all the above embodiments, it at least has all the beneficial effects brought by the technical solutions of the above embodiments, which will not be repeated here.

The foregoing is merely some or preferred embodiments of the present invention. Neither the foregoing description nor the accompanying drawings shall be construed to limit the scope of protection of the present invention in any manner. Any equivalent structural variations made by utilizing the contents of the present specification and drawings under the overall inventive concept of the present invention, as well as direct or indirect applications in other related technical fields, are all encompassed within the scope of protection of the present invention.

What is claimed is:

1. A detachable supporting foot, comprising a base, a driving component, a return elastic component, and a spike component; wherein the driving component, the return elastic component, and the spike component are mounted on the base, the spike component is used for external connection to a leg, the driving component is pivotally connected to the base;
the driving component comprises a pressing portion and a catch hook; the driving component is movable between a first position and a second position;
at the first position, the catch hook is hooked with the spike component;
at the second position, the catch hook is separated from the spike component so that the spike component can be detached from the base, and the return elastic component applies a restoring force to the driving component to return to the first position, actuating the pressing portion to cause the driving component to move.

2. The detachable supporting foot according to claim 1, wherein the spike component is rotatably connected to the base through a pivot shaft, the catch hook has a hook groove adapted to receive the pivot shaft, and the catch hook and the pivot shaft have a hooked state and a disengaged state.

3. The detachable supporting foot according to claim 2, wherein the base is recessed with a mounting groove, the pressing portion is located outside the mounting groove, one end of the return elastic component is connected to an inner groove wall of the mounting groove, and the other end of the return elastic component is fixedly connected to the driving component, and the pivot shaft passes through the hook groove and is rotatably connected to the inner groove wall of the mounting groove.

4. The detachable supporting foot according to claim 3, wherein the return elastic component is a spring or made of elastic material.

5. The detachable supporting foot according to claim 4, wherein the return elastic component comprises an extending portion, a first circular portion, and a second circular portion; the first circular portion protrudes from one end of the extending portion, the second circular portion protrudes from the other end of the extending portion; the inner groove wall of the mounting groove is recessed with a first circular limiting groove matching the first circular portion, and the driving component is recessed with a second circular limiting groove matching the second circular portion.

6. The detachable supporting foot according to claim 5, wherein the first circular limiting groove is connected to a first elongated groove, and an end of the first elongated groove distal from the first circular limiting groove is open; and/or
the second circular limiting groove is connected to a second elongated groove, and an end of the second elongated groove away from the first circular limiting groove extends out of a side edge of the driving component.

7. The detachable supporting foot according to claim 6, wherein the driving component comprises two connecting portions, an outer side surface of a first end of the connecting portion is rotatably connected to the inner groove wall of the mounting groove through a shaft rod, a second end of the connecting portion extending upward has the catch hook, a third end of the connecting portion is fixedly connected to the pressing portion, a receiving space is formed between the two connecting portions to rotatably receive a portion of the spike component, the first end portion, the second end portion, and the third end of the connecting portion are distributed in a triangular shape, and the second circular limiting groove is located between the first end portion and the second end of the connecting portion; and/or
the extending portion is elongated in shape.

8. The detachable supporting foot according to claim 3, wherein the bottom groove wall of the mounting groove is provided with a supporting portion protruding therefrom, and when the spike component rotates, a bottom side of the spike component is provided with a sliding portion that slides along a top surface of the supporting portion; and/or
the bottom side of the spike component is provided with two conical spikes spaced apart from each other; and/or
an upper surface of the catch hook is an arc surface, and the pivot shaft slides along the arc surface of the catch hook to slide into the hook groove.

9. The detachable supporting foot according to claim 1, wherein the driving component is pivotally mounted to the base via a shaft rod, the driving component being rotatable about the shaft rod between the first position and the second position; the spike component is pivotally connected to the base via a pivot shaft arranged parallel to the shaft rod, such that an angular position of the spike component relative to the base is adjustable and the spike component is locked at a present angle through engagement between the catch hook and the pivot shaft.

10. The detachable supporting foot according to claim 1, wherein the return elastic component is an extension elastic component, one end of the return elastic component is connected to the base, and the other end of the return elastic component is connected to the driving component; or the return elastic component is a torsion elastic component sleeved on the shaft rod, and two torsion arms thereof respectively abut against the base and the driving component.

11. The detachable supporting foot according to claim 10, wherein the return elastic component comprises an elongated extending portion, a first circular portion, and a second circular portion, and the first circular portion and the second circular portion being respectively disposed at two ends of the extension portion; the base is formed with a first circular limiting groove matching the first circular portion, and the driving component is formed with a second circular limiting groove matching the second circular portion.

12. The detachable supporting foot according to claim 11, wherein the pivot shaft is located on the extending portion when the spike member is mounted to the base.

13. The detachable supporting foot according to claim 9, wherein the catch hook is formed with a hook groove adapted to the pivot shaft, an upper surface of the hook at a junction with the hook groove is a curved surface, and the pivot shaft is capable of sliding along the upper surface of the hook to slip into the hook groove.

14. The detachable supporting foot according to claim 9, wherein the base is provided with a support portion, the spike component is provided with a sliding portion at a bottom thereof; a bottom surface of the sliding portion is curved about the pivot shaft, and a top surface of the support portion is correspondingly recessed to form a curved surface, such that the sliding portion slides smoothly on the support portion when adjusting the angular position of the spike component relative to the base.

15. The detachable supporting foot according to claim 14, wherein two conical spikes spaced apart from each other protrude from the bottom of the spike component for fixing and preventing sliding, and the sliding portion is formed between the two conical spikes.

16. The detachable supporting foot according to claim 1, wherein a leg connecting sleeve is provided at an upper portion of the spike component for connection with a leg portion, the leg portion capable of being inserted into the leg connecting sleeve to be secured thereto.

17. A supporting leg with a supporting foot, comprising a leg portion and the detachable supporting foot according to claim 1, wherein a bottom end of the leg portion is fixedly connected to the spike component.

18. The supporting leg with a supporting foot according to claim 17, wherein the leg portion is telescopically arranged.

19. A photography stand, comprising a mounting seat and three supporting legs according to claim 17, wherein an upper end portion of each supporting leg is rotatably connected to the mounting seat.
